(19) United States
(12) Patent Application Publication
(10) Pub. No.: US 2002/0196269 A1
(43) Pub. Date: Dec. 26, 2002

(54) Method and apparatus for real-time rendering of edited video stream

(75) Inventors: Shaojun Mo, HangZhou (CN); Rusong Fang, HangZhou (CN); Qinggen Chen, Fremont, CA (US)

Correspondence Address: PATENT LAW GROUP LLP, 2635 NORTH FIRST STREET, SUITE 223, SAN JOSE, CA, 95134, US

(73) Assignee: ArcSoft, Inc.

(21) Appl. No.: 09/891,613

(22) Filed: Jun. 25, 2001

(51) Int. Cl. G09G 5/00

(52) U.S. Cl. 345/721; 345/723; 345/726

(57) ABSTRACT

A system and process for real-time rendering of video images. A computer processes a set of video clips, images, and stills and simultaneously displays them on a screen. At any given time, a program processes the set along with transition and special effect frames and displays them to an observer.

### BACKGROUND OF THE INVENTION

1. Field of the Invention

The present invention relates to systems for and processes of displaying video images in real-time.

2. Description of Related Art

Several video editing software packages for home and business computers are available to the public. These packages allow users to process, order, and merge video clips and still images, add transitions and special effects, render changes, and display results on a computer screen.

Of particular interest is how the prior art packages render the changes. “To render” means to process requested effects and then present them on a monitor or screen to a user or observer. A limiting factor in the prior art is that rendering is performed as a batch process. That is, user requests are collected, stored, and then executed upon command. This usually means that the user or observer must wait to view a completed video until the batch rendering is complete.

Therefore, there is a need for providing real-time rendering of video images.

### SUMMARY OF THE INVENTION

This invention provides a system and process for real-time rendering of video images. A computer processes a set of video clips, images, and stills and simultaneously displays them on a screen. At any given time, a program processes the set along with transition and special effect frames and displays them to an observer. For the purpose of this invention, real-time means matching a processor's activities to human perception of time. Thus, as video is edited, this invention updates images on a monitor or screen at the same rate at which objects move in the real world.

### BRIEF DESCRIPTION OF THE DRAWINGS

The invention will now be described with reference to the accompanying drawings, wherein:

FIG. 1 is a block drawing of a system for providing real-time rendering of a series of video clips and still images according to one preferred embodiment of the present invention.

FIG. 2 is a flow chart of the steps performed by a processor implementing the function of real-time rendering according to one preferred embodiment of the present invention.

FIG. 3 is a flow chart of the steps performed by a processor implementing the main function of real-time rendering according to the computer source code in Listing 1.

FIG. 4 is a flow chart of the steps performed by a processor implementing the checkplay function of real-time rendering according to the computer source code in Listing 1.

### DETAILED DESCRIPTION OF THE PREFFERED EMBODIMENTS

The following description is of the best presently contemplated modes of carrying out the invention. This description is made for the purpose of illustrating the general principles of the invention and is not to be taken in a limiting sense.

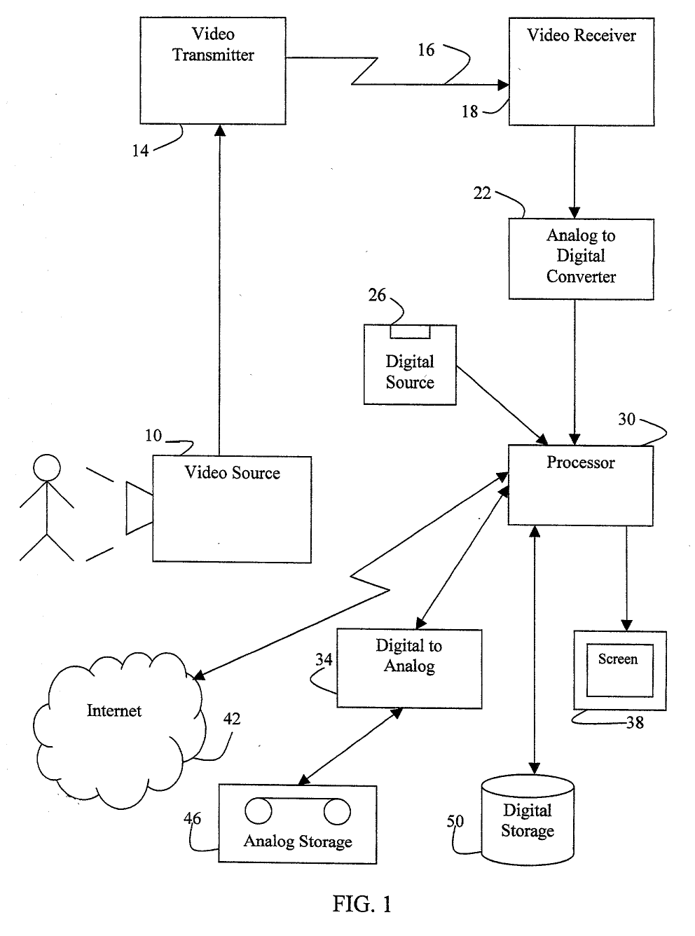

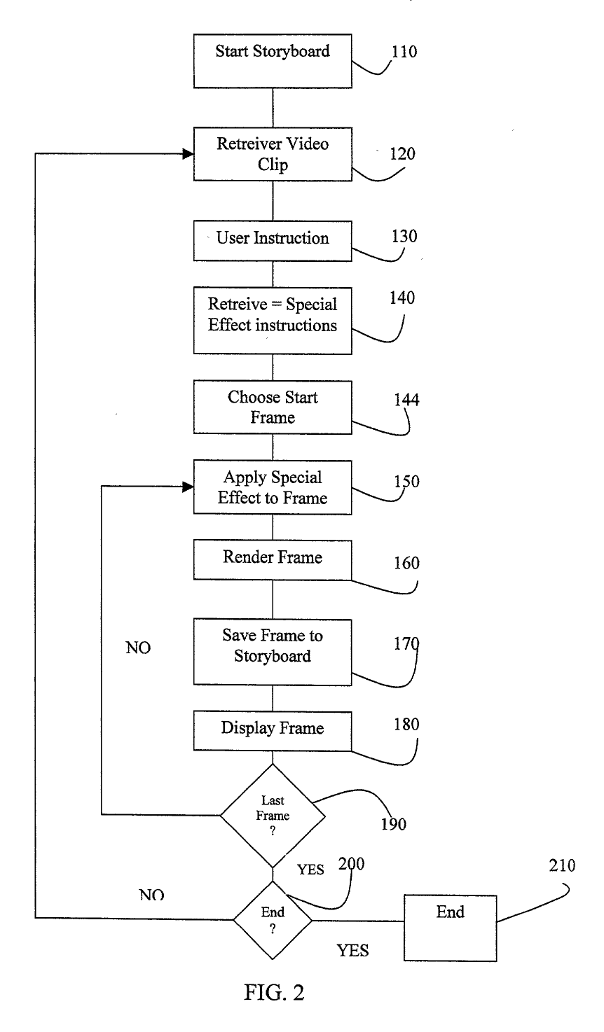

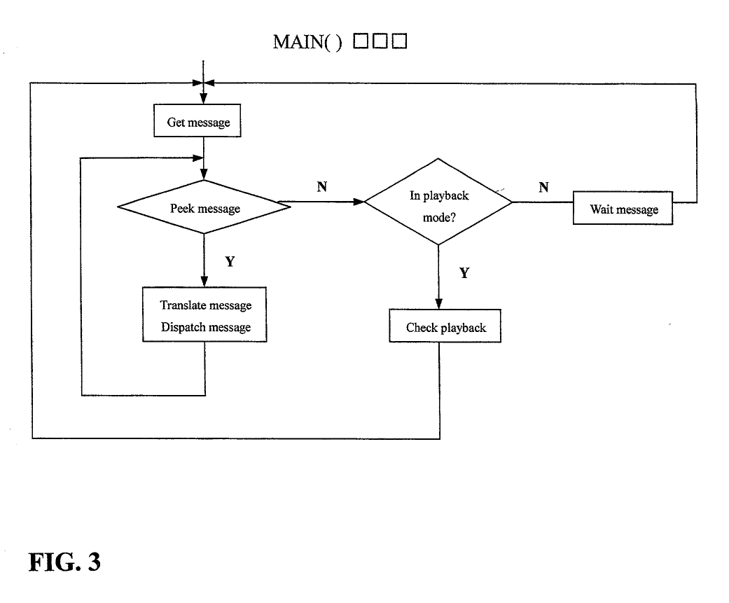

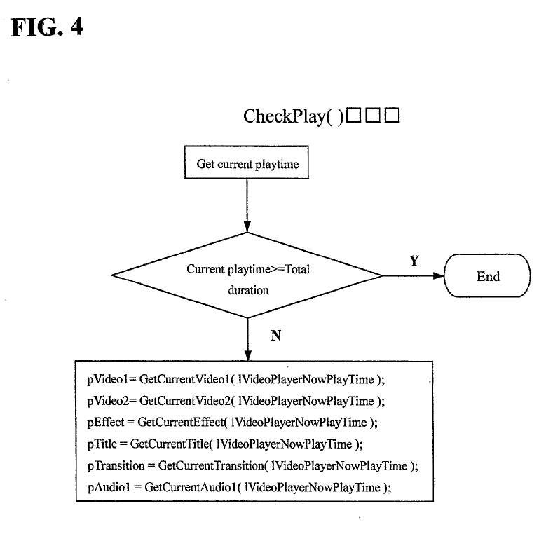

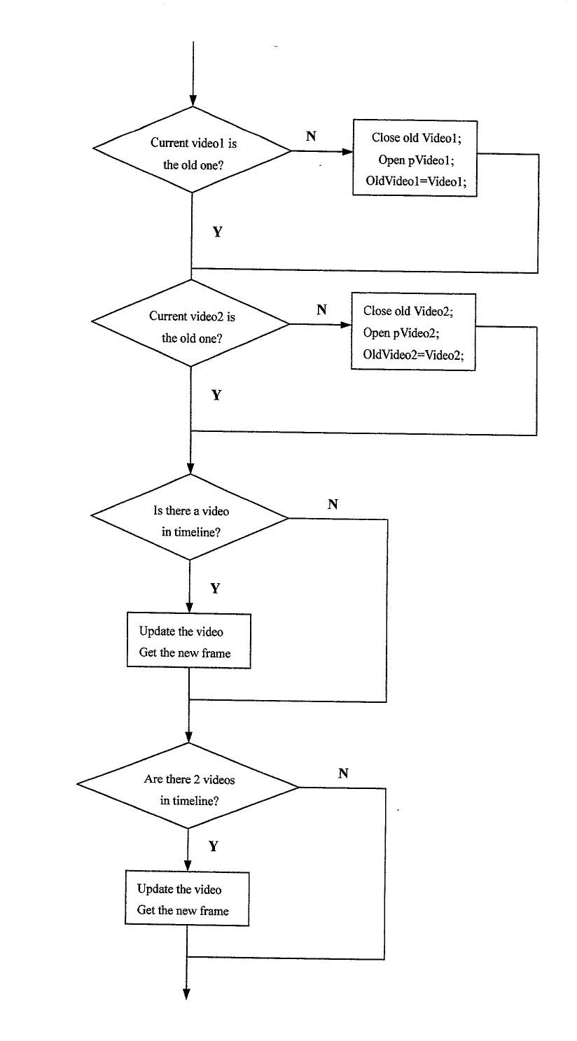

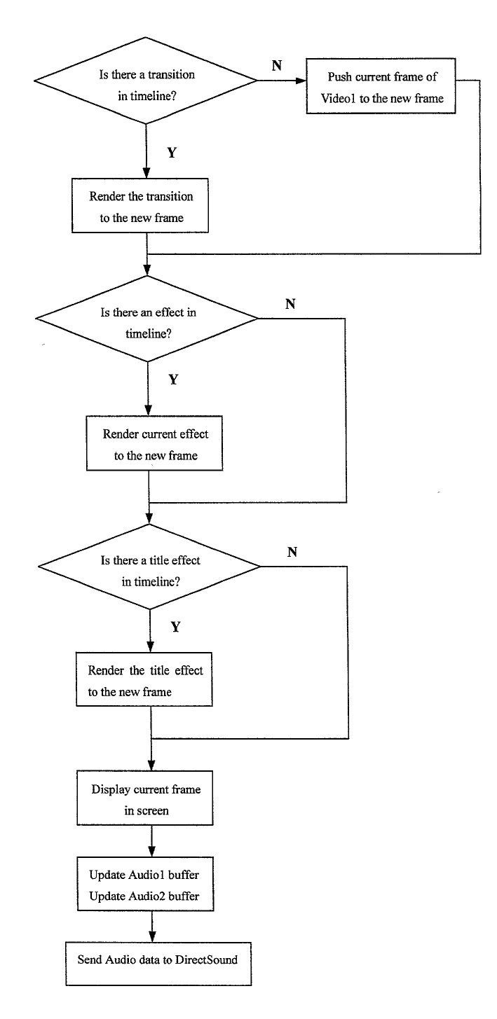

FIG. 1 illustrates a preferred embodiment of a system of real-time rendering of video data.

From a video source 10 (such as a camera) video images may be sent via a video transmitter 14 over communications link 16 to a video receiver 18. If the video is in analog format, it passes through an analog to digital converter 22 before passing to processor 30.

If video is available from a digital source 26, video may proceed directly to processor 30. Processor 30 may store and retrieve data and video on digital storage 50. Processor 30 executes user instructions, made available from a variety of sources such as a mouse and a keyboard (not shown). Processor 30 may then send video output to any of a variety of destinations. For example, it may send a real-time video stream to a screen 38. Or it may send video to a digital to analog converter 34 and onto analog storage 46 (e.g., video tape for use with a VCR). Processor 30 may also forward video output to a communications link for transmission via the Internet 42, for example.

We claim:

1. A system for manipulating video data in real-time comprising:
means for acquiring video images,
means for converting any analog video images into digital images,
means for storing digital images,
means for retrieving, editing, and merging digital images, and
means for displaying digital images to an observer in real-time.

2. A process for manipulating video data in real-time comprising;
steps for acquiring video images,
steps for converting any analog video images into digital images,
steps for storing digital images,
retrieving a first set of digital images,
retrieving a second set of digital images,
making a transition effect to compose new frames,
making a special effect to compose additional new frames,
merge the new frames with the first and second set of digital images,
display the result to an observer, and
repeat the process as a user requests.
